(19) United States
(12) Patent Application Publication
(10) Pub. No.: US 2012/0061330 A1
(43) Pub. Date: Mar. 15, 2012

(54) WATER TREATMENT ARTICLES

(76) Inventors: LAIRD WASHBURN, Fruit Heights, UT (US); Sean Terry, Gilbert, AZ (US)

(21) Appl. No.: 13/223,022

(22) Filed: Aug. 31, 2011

Related U.S. Application Data
(60) Provisional application No. 61/378,775, filed on Aug. 31, 2010.

(51) Int. Cl. C02F 5/10

(52) U.S. Cl. 210/749; 210/198.1

(57) ABSTRACT

Water treatment products designed for use in cleaning machines such as dishwashers or laundry washers are disclosed. The water treatment products are in the form of a water semi-permeable pouch comprising a water treatment composition which may include a water treatment composition such as citric acid. Additionally, rather than putting the semi-permeable pouch directly in the cleaning machine, the pouch may be housed in a canister though which water added to the machine passes. Methods for treating water in cleaning machines using the water treatment products are also disclosed.

### REFERENCE TO EARLIER FILED APPLICATION

The present application claims the benefit of the filing date under 35 U.S.C. §119(e) of Provisional U.S. Patent Application Ser. No. 61/378,775, filed Aug. 31, 2010, which is hereby incorporated by reference in its entirety.

### BACKGROUND OF THE INVENTION

The present invention relates to water treatment and cleaning. More specifically, the invention relates to an article in the form of a water semi-permeable pouch comprising a water treatment composition, such as citric acid, and processes for using the article to treat water and clean dishes, laundry, plumbing fixtures such as a toilet, drains, garbage disposals, faucets, sprayers, shower heads, and the like.

The interior surfaces of dishwashers, washing machines, or similar devices can become covered with residues after repeated use. Moreover, articles cleaned in such devices such as dishes and clothing can also become covered with residues. The kind of residues found most frequently are limescale, soap scum, and soil deposits (for example, food residues in the case of dishwashers). Limescale is formed from the insolubilisation of ions contained in tap water. The limescale deposits can be found on various components of the machines, including the heater elements, tubs, and racks. They can also be seen on transparent articles such as drinking glasses. Such deposits are undesirable. They can interfere with the cleaning processes, are aesthetically displeasing, and can also interfere with the heat exchange process (such as in automatic dishwashers) resulting in a less efficient use of energy. In addition, soap scums which are remnants from the detergents that interact with minerals in hard water, also build-up on the interior of machines and on articles washed by those machines.

There is, therefore, a need to provide a simple device that could be used in a cleaning machine wash cycle that permits dispersion of water treating compositions and which is safe and easy for handling and shipping.

### SUMMARY

In one aspect of the invention, a water treatment article comprises a packet having a single compartment comprising a spunbond polyolefin and a heat seal adhesive; and a water treatment composition comprising one or more of the following: dried extracts from citrus fruits, citric acid, and baking soda.

In some embodiments, the heat seal adhesive is selected from an ethylene copolymer and polyethylene. In some embodiments, the spunbond polyolefin is not corona treated. In some embodiments, the spunbond polyolefin is high-density polyethylene. In some embodiments, the spunbond polyolefin is high-density polypropylene. The heat seal should be of a sufficient width to keep the article intact for normal handling. For example, the heat seal may be between ¼ and ½ inches wide.

In some embodiments, the compartment comprises a plurality of walls, wherein a first wall is semipermeable to water and second wall is not permeable to water. In some embodiments, the spunbond polyolefin has a Gurley Hill porosity of about 28 to about 33 seconds. In some embodiments, the packet comprises between about 0.3 and about 8 ounces of the water treatment composition. In some embodiments, the water treatment composition is in the form of a granulated powder. In some embodiments, the water treatment composition is in the form of one or more tablets.

In another aspect of the invention, a water treatment article for use in a dishwasher comprises a packet comprising a single compartment comprising a spun bond high-density polyolefin and a heat seal adhesive, and a water treatment composition comprising one or more of the following: dried extracts from citrus fruits, citric acid, and baking soda, wherein the water treatment composition is in the form of a granulated powder or one or more tablets and wherein the permeability of the packet and the solubility of the water treatment composition are such that the article dispenses between about 0.3 and about 0.9 ounces of the water treatment composition per operating cycle of the dishwasher.

In another aspect of the invention, a water treatment system is disclosed which includes (a) a vessel having an inlet connected to a water line and an outlet connected to an apparatus that uses treated water, and a flow path within the vessel between the inlet and the outlet; (b) a packet comprising a single compartment comprising a spunbond polyolefin and a heat seal adhesive wherein the packet is enclosed within the vessel so as to be contacted by water following said flow path; and (c) a water treatment composition within the packet comprising one or more of the following: dried extracts from citrus fruits, citric acid, and baking soda.

In another aspect of the invention, a method of treating water in a cleaning machine comprises providing a water treatment article comprising a packet comprised of a spunbond high-density polyolefin and a heat seal adhesive and a water treatment composition comprising one or more of the following: dried extracts from citrus fruits, citric acid, and baking soda; placing the article in a cleaning machine for a first application; and contacting the article in the cleaning machine with water during the first application.

In some embodiments, the method includes contacting the article in the cleaning machine with water for a second application. In some embodiments, the method includes contacting the article in the cleaning machine with water for a third application.

In some embodiments, the article used in the method dispenses between about 0.3 and about 0.9 ounces of the water treatment composition per water treatment application.

### BRIEF DESCRIPTION OF THE DRAWINGS

FIG. 1 is perspective view of a water treatment article in the form of a rectangular shaped pouch with a single chamber.

FIG. 2 depicts in cross-sectional view a water treatment article in the form of a rectangular shaped pouch with a single chamber.

FIG. 3 depicts in plan-view a water treatment article in the form of a rectangular shaped pouch with a single chamber.

FIG. 4 depicts in plan-view a water treatment article in the form of a circular shaped pouch with a single chamber.

FIG. 5 depicts in cross-sectional view a water treatment article in the form of a circular shaped pouch with a single chamber.

FIG. 6 depicts a cross-sectional view of an in-line vessel for housing the water treatment article.

FIG. 7 depicts a cross-sectional view of a cartridge contained within the in-line vessel depicted in FIG. 6.

### DETAILED DESCRIPTION

As used herein the term “nonwoven fabric or web” means a web having a structure of individual fibers or threads which are interlaid, but not in an identifiable manner as in a knitted or woven fabric. The basis weight of nonwoven fabrics is usually expressed in ounces of material per square yard (osy) or grams per square meter (gsm) and the fiber diameters useful are usually expressed in microns. (Note that to convert from osy to gsm, multiply osy by 33.91).

As used herein the term “spunbond” relating to fibers refers to small diameter fibers which are formed by extruding molten thermoplastic material as filaments from a plurality of fine, usually circular capillaries of a spinneret with the diameter of the extruded filaments then being rapidly reduced as by, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, and U.S. Pat. No. 3,542,615 to Dobo et al. Spunbond fibers are generally not tacky when they are deposited onto a collecting surface. Spunbond fibers are generally continuous and have average diameters (using a sample size of at least 10) larger than 7 microns, more particularly, between about 10 and 25 microns.

As used herein, “corona treatment” or “corona treated” refers to a surface treatment process that improves the wetting characteristics of polymers by raising surface energy (dyne level). The surface energy quantifies the disruption of intermolecular bonds that occurs when the surface is created. In conventional processes, corona treatment may involve application of an electric field through which the surface of a material is passed, such as a high-voltage, high-frequency field.

The present invention encompasses a product 1 designed for use in cleaning machines such as dishwashers or laundry washers, the product being in the form of a water semi-permeable pouch comprising a water treatment composition comprising, for example, citric acid. The present invention also includes methods for treating water in cleaning machines using such articles.

The preferred water treatment article is in the form of a single compartment pouch. Referring to the drawings, a single internal chamber or compartment 10 of the pouch is filled with a water treatment composition. The water treatment composition can pass through the nonwoven wall 20 of the pouch when the outside of the wall is wetted in a cleaning machine. For example, when the product 1 is contacted by water in a dishwasher, the wetting of the outside of the nonwoven semi-permeable wall permits water to enter into the chamber 10 and mix with the water treatment composition. The water treatment composition may then pass back through the nonwoven wall 20 and circulate in the cleaning fluid of the dishwasher.

The water treatment composition contains substances for preventing limescale or soap scum formation including citrus based products such as dried extracts from citrus juices (orange juice, lemon juice, lime juice for example) or chemicals such as baking soda. Citric acid may be used to prevent limescale or soap scum formation, such as anhydrous, FCC<USP citric acid, monohydrate. In addition, the water treatment composition may optionally include other components such as anticaking agents, desiccants (such as silica gel), buffering salts such as polyphosphate salts, sequestering agents, dyes, and perfumes.

In some embodiments, the water treatment composition in the pouch is in the form of a granulated powder. The powder may be a granular, food grade powder. In some embodiments, the water treatment composition in the pouch is in the form of a tablet.

The water treatment composition operates so that after passing outside of the chamber through the nonwoven wall, it interacts with calcium, magnesium, or other hard water ions to prevent their adhesion to the cleaning machine and the articles being washed therein. In a dishwasher for example, when dishes have surfaces where water pools (e.g. a depression or concave surface), the water treatment composition will be present in the pooled water and will prevent calcium ions from adhering to the dish surface. Thus, rather than have hard water build-up on the dish, the calcium will be bound to the water treatment composition and simply wipe or brush off after the water evaporates. In contrast, dishes washed without the water treatment composition delivered from the water treatment article, calcium or other minerals found in the untreated water would interact with the dish surface and create a film that either is difficult to wipe off or does not wipe off.

In some embodiments, the water treatment composition is essentially free of water before the water treatment article is used in a cleaning machine. In some embodiments, the water treatment composition, such as citric acid may, be wetted in the form a gel inside the pouch before the water treatment article is used in a cleaning machine.

The pouch may be made of spunbond polyolefinic materials. The pouch material can, for example, be obtained from polyethylene, polypropylene, polymethylpentene, polybutene-1, polyisobutylene, ethylene propylene rubber, and the like. Such spunbond polyolefin materials are available from a variety of commercial sources including DuPont (5401 Jefferson David Highway Richmond, Va. 23234) and Fiberweb (70 Old Hickory Blvd., Old Hickory, Tenn. 37138).

In some embodiments, the polyolefinic material is not corona treated.

The spunbond polyolefinic material should be selected so that when the pouch is placed in a cleaning machine, an appropriate amount of the water treatment composition is dispensed during a washing cycle. It should, therefore, be semipermeable to water but not so permeable that upon wetting, more than the necessary amount of water treatment composition is dispensed into the cleaning machine. In addition, the spunbond polyolefinic material should be flexible so that it may be processed in high speed processing equipment capable of filling and sealing the pouches.

In some embodiments, the polyolefinic material includes a heat seal adhesive. A variety of heat seal adhesives are available, including ethylene copolymers and polyethylene. In general, the heat seal adhesive should have a melting point which his less than that of the spunbond polyolefinic material. The heat seal adhesive may be applied to the polyolefinic material through a variety of techniques, including rotogravure or gravure cylinders.

The water treatment article can have a shape and size suitable for fitting within the cleaning machine. Thus, the water treatment article may be used in a variety of cleaning machines and with a variety of articles which the cleaning machines may clean.

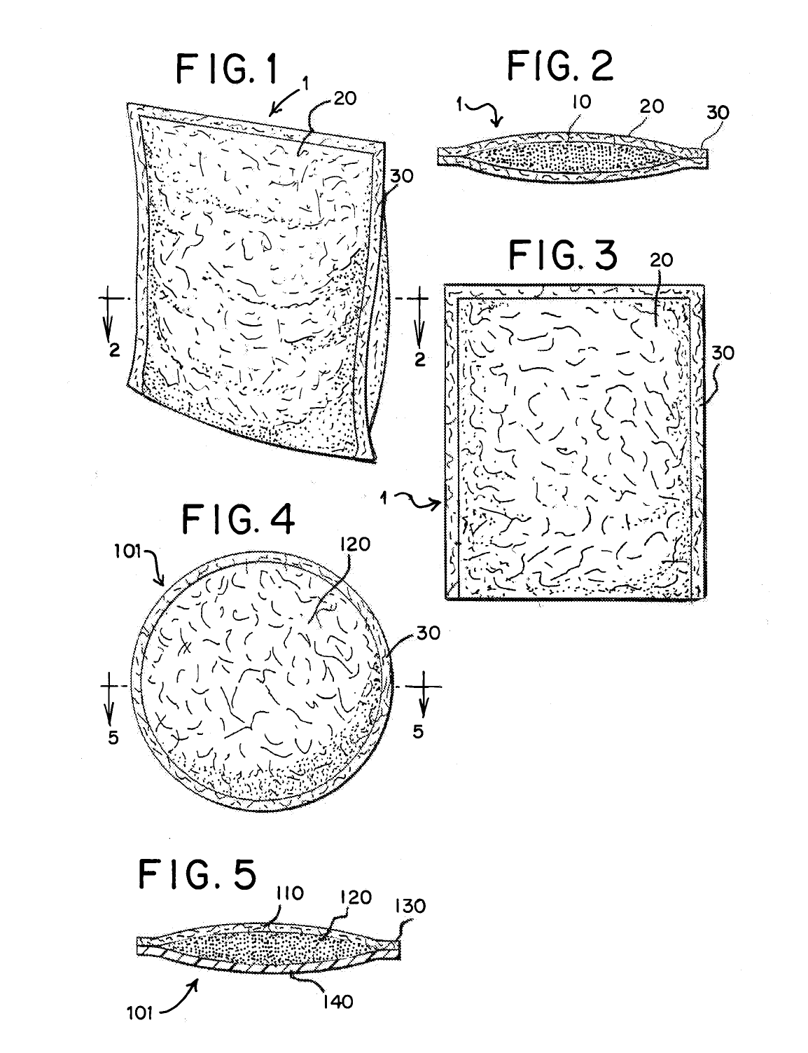

The preferred water treatment article is in the form of a single compartment pouch. Referring to FIGS. 1, 2, and 3, a single internal chamber or compartment 10 of the pouch is filled with a water treatment composition. The water treatment composition can pass through the nonwoven wall 20 of the pouch when the outside of the wall is wetted in a cleaning machine. For example, when the product 1 is contacted by water in a dishwasher, the wetting of the outside of the nonwoven semi-permeable wall permits water to enter into the chamber 10 and mix with the water treatment composition. The water treatment composition may then pass back through the nonwoven wall 20 and circulate in the cleaning fluid of the dishwasher.

In some embodiments, the compartment of the pouch is bounded by walls of the pouch that are seamed together at the edges by a single or plurality of heat seals. For example, a continuous heat seam 30 is shown in FIGS. 1-3. As shown in FIGS. 1-3, product 1 is rectangularly shaped.

In some embodiments, the compartment is bounded by walls of the pouch that are seamed together at the edges by a noncontinuous heat seal. For example, a portion of the perimeter of a pouch may include a heat seal segment and a fold in the polyolefinic material, as seen in FIGS. 1 and 3.

In some embodiments, the pouch has at least one wall which is semipermeable to water. For example, as shown in FIG. 5, product 101 has a compartment 110, a first wall 120 that is made of a semipermeable spunbond polyolefinic material, and a second wall 140 that is made of material not permeable to water. As shown in FIGS. 4 & 5, product 101 is circularly shaped with a continuous heat seam 130.

The water treatment article, therefore, may be made into a variety of shapes and configurations which are made from form, fill, and seal machines. A variety of automated and semi-automated assembly-line packaging product packaging systems are available to one of ordinary skill in the art.

In some embodiments, at least one wall which is semi-permeable to water has a Gurley porosity of between about 28 and about 33 seconds. In some embodiments, at least one wall which is semi-permeable to water has a Gurley porosity of between about 29 and about 32 seconds. In some embodiments, at least one wall which is semi-permeable to water has a Gurley porosity of about 31 seconds.

In some embodiments, the water treatment article dispenses between about 0.3 ounces and 0.9 ounces of the water softening composition per use. In some embodiments, the polyolefinic material may be selected to permit about 0.6 ounces or less of water softening composition per application or wash cycle. In some embodiments, the polyolefinic material may be selected to permit about 1.75 ounces or less of water softening composition for three applications, such as normal dishwasher operating cycles. A normal dishwashing operating cycle can, for example, include prewash, washing, first and second rinse cycles, and an active drying cycle. In some embodiments, the dishwasher can be operated with the water treatment article without a prewash cycle. In some embodiments, the dishwasher can be operated with the water treatment article without an active drying cycle. In some embodiments, the dishwasher can be operated with the water treatment article in a single rinse cycle.

A variety of parameters may be altered to affect the appropriate dispensing of the water treatment composition through the water treatment article. These parameters include the amount of water treatment composition, the size of the pouch and geometry of the pouch (and related surface area), the material comprising the walls of the pouch, the porosity of the material comprising the walls of the pouch, whether the wall material is corona treated, the type and form of water treating material, and the solubility of the water treatment composition. The selection of these various parameters is within the skill of one of ordinary skill in the art.

In some embodiments, the polyolefinic material has a hydrostatic head of greater than 15 inches of water. In some embodiments, the polyolefinic material has a hydrostatic head of greater than 30 inches of water. In some embodiments, the polyolefinic material has a hydrostatic head of greater than 40 inches of water. In some embodiments, the polyolefinic material has a hydrostatic head of greater than 50 inches of water. The hydrostatic head (water resistance) can be measured using test method AATCC 127, which describes the pressure resistance of a material to the penetration of water under a static load.

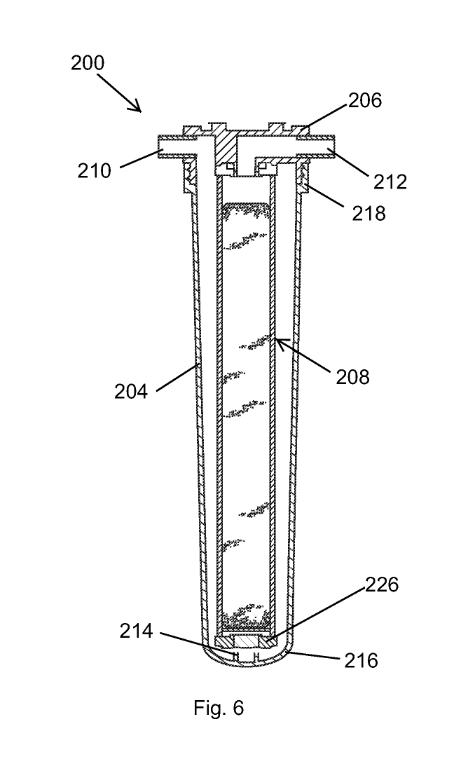

In another aspect, an in-line vessel may be used to hold the water treatment article for dispensing the water treatment composition in a water supply. Referring to FIG. 6, a vessel 200 is shown in cross-sectional view. The in-line vessel 200 includes a pressure vessel 204 coupled to a main head 206 at a first end 218 to which a cartridge 208 has been coupled. The main head 206 includes an inlet 210 and an outlet 212 that are configured to be coupled with a water line through the use of any of a wide variety of fittings or connections, such as push-connect fittings, compression fittings, welds, or any other method of coupling pipe.

The cartridge 208 may contact the pressure vessel 204 at the second end 216. In some embodiments, the second end 216 of the pressure vessel 204 may include one or more ribs 214. In some embodiments such as depicted in FIG. 6, the ribs are annularly located about a central axis of the pressure vessel 204. In some embodiments, the ribs are radially located about a central axis of the pressure vessel 204. In some embodiments the some ribs are radially located about a central axis of the pressure vessel, and some ribs are located annularly about the central axis of the pressure vessel 204. In some embodiments, the cartridge rests upon the ridges. In some embodiments, the cartridge fits over the ridges to form a fluid path between the cartridge and the ribs.

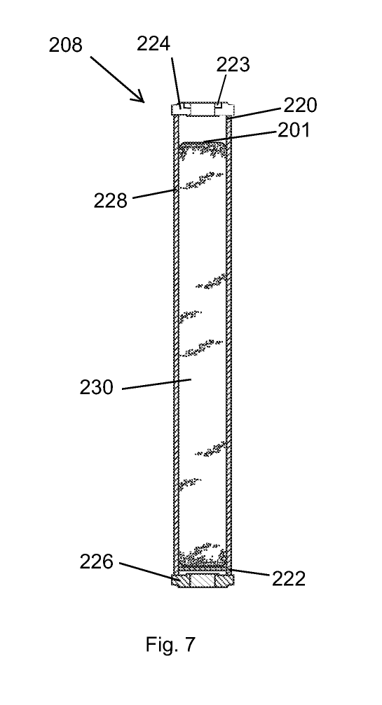

Referring to FIG. 7, a cartridge 208 like the one illustrated in FIG. 6 is shown. As illustrated, the body 228 of the cartridge 208 has a first end 220 and a second end 222 with a cartridge head 224 coupled at the first end 220 and an sieve 226 coupled at the second end 222.

In embodiments with the sieve 226, the sieve may act as a filter to block passage of particulates such as sand from passing further through the water line. In alternate embodiments (not shown), the sieve is absent and the cartridge 208 has an opening at the second end 222 through which water may pass through the cartridge 208.

The body 228 of the cartridge 208 may form an annular cylindrical housing, though the body 228 may form any shaped housing depending upon the shape of the cross section of the body, such as, by non-limiting example, square, oval, elliptical, rectangular, octagonal, and any other closed shape.

Within the cartridge, a chemical 230 is disposed within a water treatment product 201 such as the product 1 depicted in FIGS. 1-3 or product 101 depicted in FIGS. 4 and 5. The water treatment product 201 is contained within the body 228. In some embodiments, the cartridge head 224 may also include a sealing member 223 such as an elastomeric material for abutting the main head 206 of the in-line vessel 200 (see FIG. 6). The sealing member 223 prevents water from passing from an internal cavity of the pressure vessel 204 to the outlet 212 without first passing through the cartridge 208 and over the water treatment product 201.

Referring again to FIG. 6, the cartridge 208 containing the water treatment product 201 may operate in conjunction with a main head 206 and pressure vessel 204 when water is passed through the vessel 200 as follows. Water flows through inlet 210 into the internal cavity of the pressure vessel 204. Water from the internal cavity flows through the sieve 226 (or in alternate embodiments not shown through an opening of the cartridge) and over the water treatment product 201. Treated water then exits the cartridge 208 and passes through outlet 212.

Water treatment product pouches used in such vessels can be larger sizes than those used in individual cleaning devices. For example, the water treatment product used in an in-line vessel may contain 8 oz. of water treatment composition.

The treated water passing over the water treatment product 201 can be provided from the in-line vessel 200 to a variety of end uses. Such end uses include cleaning devices such as dishwashers, laundry washers, and the like. The treated water may also be provided to other devices and for other uses such as drinking water, shower water, and the like. The treated water may also be used in ice machines.

### PROPHETIC EXAMPLES

A water treatment article can be made of a spunbond high-density polyethylene material, DuPont Tyvek® 2025B, with a weight of 1.39 oz/square yard having a heat seal adhesive. The article can be about 4 inches by about 5 inches in dimension. The article can be filled with 2 ounces of citric acid. The water treatment article can be heat sealed along the entire perimeter of the article thereby encapsulating the citric acid.

A second water treatment article can be made of a spunbond high-density polyethylene material, DuPont Tyvek® 2025B, with a weight of 1.39 oz/square yard having a heat seal adhesive. The article can be about 4 inches by about 5 inches in dimension. The article can be filled with 8 ounces of citric acid. The water treatment article is heat sealed along the entire perimeter of the article thereby encapsulating the citric acid.

A third water treatment article can be made of a Reemay material (product no. 2024-717), 2.1 osy 5 micron, from Fiberweb having a heat seal adhesive, sealed along the entire perimeter of the article. The article can be filled with citric acid. The article can be about 4 inches by about 5 inches in dimension.

The water treatment articles can be placed in a dishwasher, and the dishwasher can be loaded with soiled dishes and transparent drinking glasses with visible film on the glasses. The dishwasher can be activated and run on a normal cleaning cycle having wash and rinse cycles. After completing the cleaning cycle, the glasses can dry and be visibly inspected.

The water treatment articles may be added to a toilet reservoir (tank) or simply clipped to the tank chain. The water treatment articles may be added to a water reservoir that will supply water to plumbing fixtures such as showerheads and drains.

### Prophetic Comparative Example

A water treatment article can be made using spunbond high-density polyethylene material corona treated DuPont Tyvek® 2058R having a heat seal adhesive. The water treatment article can be filled with 8 oz. of citric acid and heat sealed along the entire perimeter of the article. The water treatment article can be placed in a dishwasher, and the dishwasher can be loaded with soiled dishes and transparent drinking glasses with visible film on the glasses. The dishwasher can be activated and run on a normal cleaning cycle. After completion of the cleaning cycle, the glasses can be allowed to dry and visibly inspected. The article can be observed to have dispensed much of or all of the 8 ounces of citric acid, thereby being too permeable and ineffective for repeated uses.

The systems and water treatment articles described above are effective for preventing limescale buildup and removing limescale from plumbing and cleaning appliances. They also provide the advantage of preventing buildup of limescale from drinking water systems.

In systems containing in-line delivery of the water treatment, such systems can be advantageous to hold and dispense water treatment chemicals which require infrequent changing or recharging. Moreover, such systems can avoid problems associated with water treatment articles in cleaning devices such as dishwashers that may be susceptible to being torn or cut open. And such systems may be used for water systems that supply water to more than a single appliance or water outlet.

What is claimed is:

1. A water treatment article comprising:
a) a packet comprising a single compartment comprising a spun bond polyolefin and a heat seal adhesive; and
b) a water treatment composition comprising one or more of the following: dried extracts from citrus fruits, citric acid, and baking soda.

2. The water treatment article of claim 1 wherein the heat seal adhesive is selected from an ethylene copolymer and polyethylene.

3. The water treatment article of claim 1 wherein the spunbond polyolefin is not corona treated.

4. The water treatment article of claim 1 wherein the spunbond polyolefin comprises high-density polyethylene.

5. The water treatment article of claim 1 wherein the spunbond polyolefin comprises high-density polypropylene.

6. The water treatment article of claim 1 wherein the compartment comprises a plurality of walls, wherein a first wall is semipermeable to water and second wall is not permeable to water.

7. The water treatment article of claim 1 wherein the article has a Gurley Hill porosity of about 28 to about 33 seconds.

8. The water treatment article of claim 1 wherein the packet comprises between about 0.3 and about 8 ounces of the water treatment composition.

9. The water treatment article of claim 1 wherein the water treatment composition is a granulated powder.

10. The water treatment article of claim 1 wherein the water treatment composition comprises one or more tablets.

11. A method of treating water in a cleaning machine comprising:
a) providing a water treatment article comprising a packet comprised of a spunbond high-density polyolefin and a heat seal adhesive and water treatment composition comprising one or more of the following: dried extracts from citrus fruits, citric acid, and baking soda;
b) placing the article in a cleaning machine for a first application; and
c) contacting the article in the cleaning machine with water during the first application.

12. The method of claim 11 further comprising contacting the article in the cleaning machine with water for a second application.

13. The method of claim 12 further comprising contacting the article in the cleaning machine with water for a third application.

14. The method of claim 11 wherein the article dispenses between about 0.3 and about 0.9 ounces of the water treatment composition per water treatment application.

15. A water treatment system comprising:
(a) a vessel having an inlet connected to a water line and an outlet connected to an apparatus that uses treated water, and a flow path within the vessel between the inlet and the outlet;
(b) a packet comprising a single compartment comprising a spun bond polyolefin and a heat seal adhesive wherein the packet is enclosed within the vessel so as to be contacted by water following said flow path; and
(c) a water treatment composition within the packet comprising one or more of the following: dried extracts from citrus fruits, citric acid, and baking soda.

16. The water treatment system of claim 15 wherein the spunbond polyolenfin has a hydrostatic head of greater 15 inches of water.

17. The water treatment system of claim 15 wherein the vessel further comprises a cartridge containing the packet, wherein the cartridge is in-line with a water line.

18. The water treatment system of claim 17, wherein the cartridge is in-line with the water inlet.

19. The water treatment system of claim 15, wherein the system is in-line with the water inlet to a dishwasher.
